(19) United States
(12) Patent Application Publication
(10) Pub. No.: US 2008/0149281 A1
(43) Pub. Date: Jun. 26, 2008

(54) Method and Means for Creating an Unobtrusive and Portable Environmental Barrier for Windows

(75) Inventor: Chriss Ann Krowchenko, Woodstock, CT (US)

Correspondence Address: CHRIS A. KROWCHENKO, 1230 ROUTE 197, WOODSTOCK, CT, 06281, US

(73) Assignee: Chriss Krowchenko, Woodstock, CT (US)

(21) Appl. No.: 11/615,956

(22) Filed: Dec. 23, 2006

(51) Int. Cl. E06B 9/24

(52) U.S. Cl. 160/242

(57) ABSTRACT

The invention provides a simple, unobtrusive method of essentially sealing a window to control environmental elements. The method is easily installed, adjusted or removed and can be used behind existing window coverings. The method consists of at least two adjustable tension rods of equal length and a supple application specific fabric. The fabric has a width equal to that of the tension rods when fully extended. The length of the fabric is equal to or greater than the length of the window to be covered. An open-ended hem large enough to encase the tension rods is sewn along the width ends of the fabric. A tension rod is inserted into each of the open-ended hems. The tension rods are adjusted to fit snuggly in the window casing. The upper rod is abutted to the top of the window casing and the lower rod is abutted to the bottom.

### BACKGROUND OF THE INVENTION

The invention pertains to the general field of window shades and covers and more particularly to a simple, yet highly effective, method of temporarily sealing a window creating a barrier to control elements of nature without impacting the integrity of the window casing or adjacent wall.

Previous art for window coverings in general require installation of an apparatus to the window casing or adjacent wall to hold the window covering in place. These apparatus include brackets, hooks, snaps, magnetic tape, magnets, Velcro, hook tape, adhesive tape and suction cups. Some use screws, bolts or nails to secure the apparatus damaging the wall or window casing-requiring repair upon removal. Others use adhesive that have the potential to remove paint or the surface of the drywall or leave an adhesive residue. Besides the potentially damaging affects the previous art poses, the installation methods are laborious and time consuming.

Previous art for window coverings that address a specific need such as preventing the loss of energy during inclement weather, blocking unwanted light, or preventing insect infestation require some sort of method to effectively seal the window. Some are designed to be temporary using rolled plastic or film attached with potentially damaging tape, magnets or Velcro. Although effective, these approaches are not aesthetically pleasing and are cumbersome to install and remove as the seasons change. Others require more complex installation methods and are of a more permanent nature.

People who work evening shifts or people who live in large metropolitan cities often need to block unwanted light. A common method involves taping newspaper or aluminum foil over the offending window(s). This potentially damaging method is aesthetically displeasing to both the implementer and the implementer's neighbor.

The need to prevent energy loss and maintain a comfortable environment during inclement weather is one of the most costly issues many households face. Unfortunately many households do not adequately insulate their windows where up to 70% of thermal energy can be lost. For ten years I endured Connecticut winters in a home with forty-two windows, with storm windows, but no additional insulation. I desperately needed to lower my energy consumption and create a comfortable living environment during the winter but I could not find a cost effective solution that could be installed and removed easily without compromising the integrity of the window casing or adjacent wall.

The least invasive apparatus designed to secure a window cover, generally a curtain, is a tension rod. The traditional use of the tension rod involves attaching a curtain to the tension rod and placing the tension rod in a window casing. The lower edge of the curtain hangs freely providing a certain amount of privacy but does not effectively create a barrier against environmental elements.

A search of the prior art did not disclose any patents that read directly on the claim of the instant invention, however the following U.S. patents were considered related:

### REFERENCES CITED

U.S. PATENT DOCUMENTS

| | | |
|---|---|---|
| 4079772 | March 1978 | Klaenhammer et al. |
| 4103728 | August 1978 | Burdette et al. |
| 4249589 | February 1981 | Loeb |
| 4347887 | September 1982 | Brown |
| 4399640 | August 1983 | Porter |
| 4436137 | March 1984 | Charles |
| 4453585 | June 1984 | Ruggeberg Sr. et al |
| 4510986 | April 1985 | Schwankl |
| 4802523 | February 1989 | Scholten, Mosteller |
| 5025848 | June 1981 | Prochaska |
| 5074022 | December 1991 | Bussert |
| 5097886 | March 1992 | Moyet-Ortiz, Tolimas |
| 5158127 | October 1992 | Schumacher |
| 5271449 | December 1993 | Herrick |
| 5368085 | November 1994 | Ruparelia |
| 5850864 | December 1998 | Decker |
| 5937596 | August 1999 | Leeuwenburgh et al. |
| 6073675 | June 2000 | Dannaher |
| 6848492 | February 2005 | Thomas |
| 6918426 | July 2005 | Westby |

### BRIEF SUMMARY OF THE INVENTION

Accordingly, several objects and advantages of my invention are an installation method that does not require attaching a permanent apparatus or adhesive of any kind to the window casing or wall saving time, labor, and the integrity of the window casing or wall. The simplicity and ease of use make my method an attractive alternative to previous art. By using application-specific fabric the method is equally efficacious for controlling energy loss, blocking unwanted light, or eliminating insect intrusion.

By attaching a minimum of two tension rods to opposite ends of a tightly woven fabric, abutting one tension rod against the top of the window casing and one at the bottom of the window casing, transparency and invasive light are completely blocked. Using this method of abutment and joining an insulating fabric to the back of a tightly woven fabric I was able to cut my electric heat and wood stove usage in half. Using this same method of abutment and using mosquito netting for the fabric allows airflow without an invasion of insects.

This method may be used with existing curtains or drapes in particular to prevent energy loss or to provide better light blockage.

The mobility of the two tension rods allows the window to be exposed in a variety of ways controlling both light and transparency.

Because the fabric's width is equal to the greatest length to which the tension rods can extend, the cover can be used on any window within the tension rod's width range simply by allowing the fabric to gather as the rod is shortened. The length of the fabric is adjusted by rolling the fabric around one of the tension rods until its length equals that of the window. This lends to the invention's portability.

### BRIEF DESCRIPTION OF THE SEVERAL VIEWS OF THE DRAWINGS

FIG. 1 illustrates a method of completely blocking transparency, light and/or energy loss with a window covering consisting of a supple fabric 5 with an open ended hem stitched on the upper most end 4 and lower most end 3. A tension rod 1 is inserted into the lower hem 3. A second tension rod 2 is inserted into the upper hem 4. The lower tension rod 1 is inserted at the extreme lower end of the window casing. The upper tension rod 2 is inserted at the extreme upper end of the window casing.

FIG. 2 illustrates a method of allowing full transparency where the lower tension rod 1 is removed from the window casing and the fabric 5 is manually rolled onto it. The lower tension rod with the rolled fabric is then reinserted directly under the upper tension rod 2.

FIG. 3 illustrates a second method of allowing full transparency by inversing the method described in FIG. 2.

FIG. 4 illustrates a method of allowing partial transparency where the upper tension rod 2 is removed and reinserted into the window casing exposing one quarter of the window. The lower tension rod 1 remains stationary keeping the fabric 5 from touching the floor.

FIG. 5 illustrates a second method of allowing partial transparency where the lower tension rod 1 is raised and placed slightly under or directly behind the upper tension rod 2 in the window casing.

FIG. 6 illustrates a third method of allowing partial transparency where the lower tension rod 1 and the upper tension rod 2 are moved to the center of the window casing.

FIG. 7 illustrates a method of adjusting the size of the window covering to accommodate a smaller window size by gathering the fabric 6 and shortening the tension rods.

### DETAILED DESCRIPTION OF THE INVENTION

A method of creating an environmental barrier with a supple fabric and at least two tension rods where:
The environmental element that the method is to bar determines the type of fabric 5.
The two width ends of the fabric are folded over, joining the wrong sides of the fabric to itself, and stitched to form an open-ended hem 3,4 large enough to easily push a tension rod through.
The fabric's finished length, including the two open-ended hems 3,4, must be equal to or greater than the length of the window casing.
The fabric's finished width must be equal to or greater than the width of the window casing.
The tension rods 1,2 length must be able to adjust to the width of the window casing.
The tension rods are inserted into the open-ended hems.

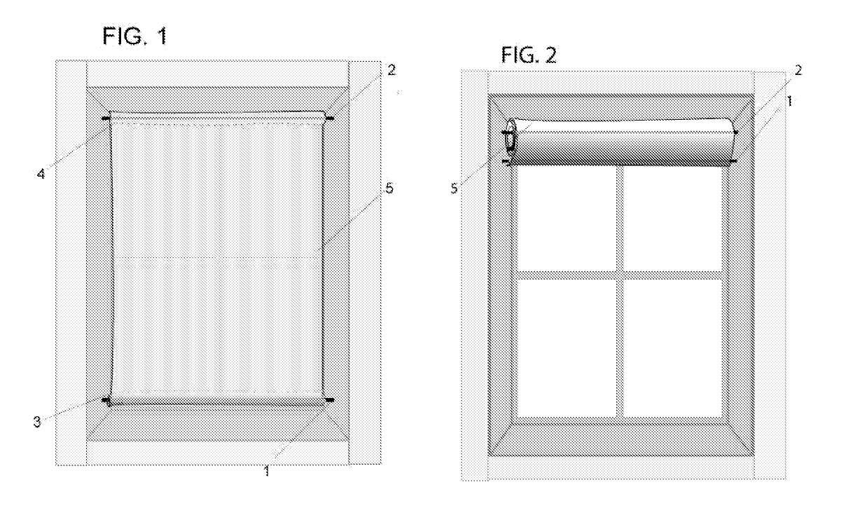

Referring to FIG. 1 that shows a method of creating a sealing environmental barrier, with a top hem 4 and a bottom hem 3, with tension rods 1 and 2 abutting the extreme bottom and top respectively of the window casing essentially sealing the window. When the sole purpose of the window covering is simply to block transparency any opaque fabric 5 would be suitable. By using a tightly woven opaque black fabric 5, complete darkness can be attained. By attaching an insulating fabric, such as Warm Windows (U.S. Pat. No. 4,397,346), to a tightly woven fabric 5, an efficient and effective method of blocking energy loss is attained. By using a mosquito-netting fabric alone, airflow without insect infestation is attained.

This method can be applied as the primary method of controlling environmental elements or installed behind existing curtains or drapes without disruption or damage to the décor.

The pliable nature of the supple fabric and the mobility of the tension rods allow great flexibility in controlling light intensity and thermal energy.

FIG. 2 and FIG. 3 demonstrates two different methods of allowing complete transparency by removing either the upper tension rod 2 or the lower tension rod 1, rolling the fabric onto the removed tension rod, and inserting the removed rod with the rolled fabric next to the stationary tension rod.

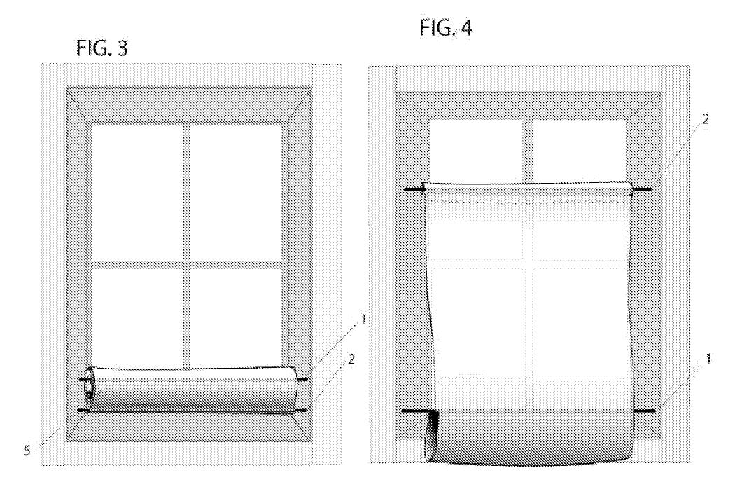

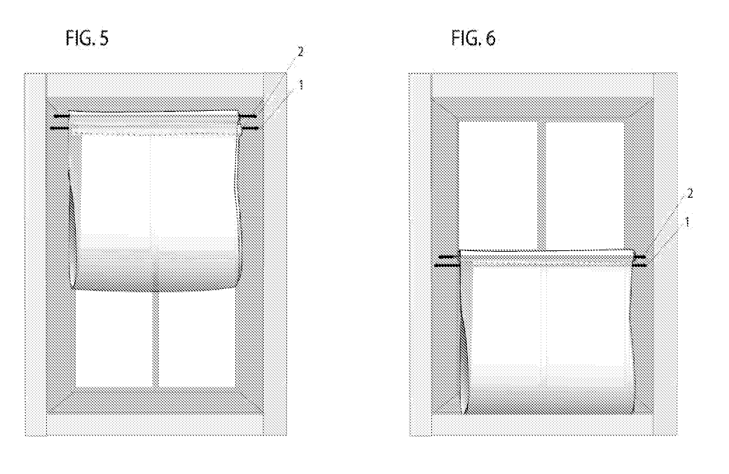

FIG. 4, FIG. 5, and FIG. 6 demonstrate the versatile nature of the method in that both tension rods can easily be removed and reinserted anywhere in the window casing providing as much or as little transparency as desired in any given application.

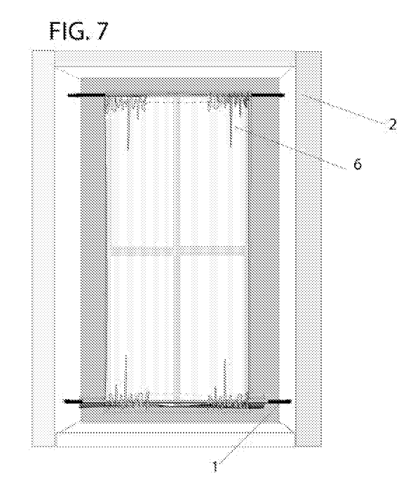

FIG. 7 demonstrates adjusting the width of the fabric to accommodate a smaller window by gathering the fabric 6 toward the middle and shortening the tension rods. All of the methods demonstrated in FIG. 2, FIG. 3, FIG. 4, FIG. 5 and FIG. 6 are used to adjust the length as needed.

1. A method and means of creating an environmental barrier that is portable and unobtrusive comprising:
(a) A supple fabric with a front surface, a back surface, an upper edge, a lower edge, a left side edge and a right side edge.
(b) Two generic tension rods of equal length that rely entirely on tension between the rod and the window casing to hold them in place.
(c) Said supple fabric is cut equal to the greatest width the tension rods can be extended and still function.
(d) The two width ends of (c) are folded over and attached to the body of the fabric forming an open-ended hem along the width of the fabric at either end of the fabric.
(e) The two tension rods (b) are inserted into the open-ended hems (d).
(f) The length of each tension rod is adjusted to fit snuggly within the window casing creating enough tension to hold the rods securely in place.
(g) To completely cover the window glass a tension rod is abutted against the extreme top and extreme bottom of the window casing.
(h) Two methods may be employed to expose part or all of the window glass:
1) one of the tension rods is removed from the window casing and moved closer to the second stationary tension rod allowing the fabric to fold once. The moving rod is then inserted back into the casing at the desired level.
2) one of the tension rods is removed from the window casing and the fabric is manually rolled onto the moving rod until the desired length is reached. The moving rod with the rolled fabric is then inserted back into the casing at the desired level.
(i) The entire window cover may be completely removed from the window by removing both of the tension rods from the window casing.
